(19) United States
(12) Patent Application Publication
(10) Pub. No.: US 2012/0109389 A1
(43) Pub. Date: May 3, 2012

(54) DISTRIBUTED POWER POINT CONTROL

(75) Inventor: Mark Covaro, Sonoma, CA (US)

(73) Assignee: REDWOOD SYSTEMS, INC., Fremont, CA (US)

(21) Appl. No.: 12/913,171

(22) Filed: Oct. 27, 2010

(51) Int. Cl. G06F 1/26

(52) U.S. Cl. 700/287

(57) ABSTRACT

A system to control power generated by a photovoltaic array is provided that may include multiple distributed power point control (DPPC) units and a distributed power point control (DPPC) controller. The DPPC units may receive power from a photovoltaic array and supply a portion of that power to a corresponding one of multiple loads. The DPPC controller may generate a control signal for each respective one of the DPPC units such that the photovoltaic array generates a target power when the DPPC units power the loads. In addition, the DPPC controller may adjust the loads and the control signal so that the photovoltaic array generates the target power.

### BACKGROUND

1. Technical Field

This application relates to photovoltaic arrays and, in particular, to controlling power generated by photovoltaic arrays.

2. Related Art

Photovoltaic cells generate electricity that may power loads. The photovoltaic cells may be included in a solar panel or photovoltaic array. The photovoltaic cells convert solar energy into direct current (DC) electricity via the photovoltaic effect. The voltage across an output of the photovoltaic cells and the current produced by the photovoltaic cells may depend on the load. In other words, the voltage and current generated by the photovoltaic cells for one load may be different than for another load. Power may be expressed as voltage multiplied by current. Thus, under a particular lighting condition, the photovoltaic cells may generate a different amount power depending on the load driven by the photovoltaic cells.

### SUMMARY

A photovoltaic array is electrically coupled to multiple loads, and the draw of each of the loads from the photovoltaic array may be controlled to provide a desired power output from the photovoltaic array.

A system may be provided that controls power generated by a photovoltaic array. The system may include a distributed power point control controller and multiple distributed power point control units. The multiple distributed power point control units may receive power from the single photovoltaic array. Each one of the distributed power point control units may supply a portion of the power received from the single photovoltaic array to a corresponding one of multiple loads. The distributed power point control controller may generate a control signal for each respective one of the distributed power point control units. The control signal may indicate a relationship between an input voltage and an output voltage of each respective one of the distributed power point control units. The distributed power point control controller may generate the control signal such that the single photovoltaic array generates a target current at a target voltage when the distributed power point control units power the loads.

A distributed power point control circuit may be provided that includes a control signal generator circuit configured to generate a control signal for each respective one of multiple distributed power point control units. The distributed power point control units may receive power from a single photovoltaic array and supply a portion of the power received from the single photovoltaic array to a corresponding one of multiple loads. The distributed power point control circuit may also include a controller module that directs the control signal generator circuit to generate the control signal for each respective one of the distributed power point control units such that the single photovoltaic array generates a target power when the distributed power point control units power the loads.

A method may be provided to control an operating point of a photovoltaic array. Multiple loads may be powered from the photovoltaic array. Voltage, current, or both that is provided to each of the loads may be controlled as a function of the operating point of the photovoltaic array. The voltage, current, or both may be controlled with control signals that correspond to the loads.

A computer readable medium may also be provided that includes a controller module configured to transmit a control signal to each respective one of a multiple distributed power point control units, where each of the distributed power point control units receives power from a single photovoltaic array and supplies a portion of the power received from the single photovoltaic array to a corresponding one of multiple loads. The controller module may determine the control signal for each respective one of the distributed power point control units that causes the single photovoltaic array to generate a target power when the distributed power point control units power the loads.

Further objects and advantages of the present invention will be apparent from the following description, reference being made to the accompanying drawings wherein preferred embodiments of the present invention are shown.

### BRIEF DESCRIPTION OF THE DRAWINGS

The embodiments may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 illustrates a first example of a distributed power point control system;

FIG. 2 illustrates an example of a combined load I-V curve;

FIG. 3 illustrates a second example of a distributed power point control system;

FIG. 4 illustrates an example of a distributed power point control circuit in a distributed power point control system;

FIG. 5 illustrates a first example flow diagram of the logic of a distributed power point control system; and

FIG. 6 illustrates a second example flow diagram of the logic of a distributed power point control system.

### DETAILED DESCRIPTION

Maximum power point tracking (MPPT) may optimize solar panel output. Maximum power point tracking involves adjusting current and voltage drawn from a solar panel so that the power produced by the solar panel falls within a range of a maximum power that the solar panel is capable of generating. When receiving a fixed amount of light, the solar panel may generate current and voltage according to an I-V curve. The I-V curve may include a collection of ordered pairs of (I, V), where I is current and V is voltage. In one example, the I-V curve may be modeled as I=Iₖ+k/(V−Vₖ), for 0<V<(Vₖ−k/Iₖ), where k, Iₖ, and Vₖ are constants and I ranges from zero to (Iₖ−k/Vₖ). Alternatively, the I-V curve may be modeled using any suitable equation or data set or is known by measurements of the photovoltaic array or similar photovoltaic array. The I-V curve may be different under different conditions. Factors affecting the I-V curve include the amount of light received by the solar panel, the amount of dirt accumulated on the panel, shading on the panel, the efficiency of the solar panel, and other factors. Power may be expressed as current multiplied by voltage. Thus, for a particular I-V curve of the solar panel, there may be a point on the I-V curve, (I_{max power} , V_{max power}), at which power is a maximum. The point at which the power is the maximum may be referred to as the maximum power point.

Just as the solar panel has I-V curves, so do loads. For example, the I-V curve for a simple resistive load may be modeled as I=(1/R)×V, where R is represents resistance. When the solar panel powers the load, the amount of current flowing from the solar panel may be the same as the current flowing into the load. The voltage across the solar panel may be the same as the voltage across the load. Therefore, when the I-V curve of solar panel is plotted on the same graph as the I-V curve of the load, the intersection point is the operating point, (Iₒₚₑᵣ, Vₒₚₑᵣ). Because the operating point may not be the maximum power point, the solar panel may not be able to deliver the maximum power to a particular load.

A maximum power point tracker (MPPT) unit may address the issue of the operating point not matching the maximum power point. An input of the MPPT unit may be electrically coupled to the solar panel. An output of the MPPT unit may be electrically coupled to the load. The MPPT unit may receive power from the solar panel and supply at least a portion of the power to the load. The MPPT unit may control the relationship between the current and voltage at the input of the MPPT unit and the current and voltage at the output of the MPPT. As a result, the MPPT unit may adjust the power drawn from the solar panel so that the solar panel supplies a maximum power level at the maximum power point to the MPPT unit, while the MPPT unit powers the load at a current and voltage level different than the maximum power point.

The MPPT unit may perform maximum power point tracking. As the maximum power point varies, the MPPT unit may adjust the relationship between the current and voltage at the input of the MPPT unit and the current and voltage at the output of the MPPT so that the solar panel continues to operate at or near the maximum power point whenever possible.

In addition, the MPPT unit may perform power conversion and regulation. For example, MPPT unit may include a voltage regulator to stabilize the voltage supplied to the load or a current regulator to stabilize the current supplied to the load. In one example, the voltage across an output of a photovoltaic array may vary by tens of volts to a hundred volts but the output of the MPPT unit may be maintained relatively stable at a target voltage, such as within five percent of the target voltage or within some other tolerance of the target voltage. The MPPT unit may handle a large amount of current if the solar panel or photovoltaic array is very large. The large amount of current passing through the single MPPT unit may decrease efficiencies, and increase local thermal loads, decreasing reliability. If the I-V curve of the load electrically coupled to the MPPT unit includes a relatively limited range of voltages, currents, or both, then the single MPPT unit may not be able to adjust so that the photovoltaic array operates at the maximum power point. A distributed power point control system may address the shortcomings of the single MPPT unit configuration.

In one example, a distributed power point control (DPPC) system to control an operating point of a single photovoltaic array is provided. The system may include multiple distributed power point control (DPPC) units and a distributed power point control (DPPC) controller. For example, the DPPC units may be electrically coupled in parallel and receive power from the single photovoltaic array. The multiple DPPC units may supply a portion of that power to respective loads. For example, the DPPC units may be switching power converters that supply power received from the photovoltaic array to light fixtures or other electrical devices. The DPPC controller may generate a control signal for each respective one of the DPPC units. For example, the control signal may be a periodic digital signal. The control signal may indicate a relationship between an input voltage and an output voltage of each respective one of the DPPC units. For example, the duty cycle, D, of the period digital signal may control the ratio of the input voltage to the output voltage as Vₒᵤₜ/Vᵢₙ=D/(1−D).

The DPPC controller may generate the control signal for each respective one of the DPPC units such that the single photovoltaic array generates a target current at a target voltage when the DPPC units power the loads. In addition, the DPPC controller may adjust the loads and the control signal so that the single photovoltaic array generates a target current at a target voltage. The target current and the target voltage may correspond to the maximum power point of the single photovoltaic array. As described in more detail below, the distributed power point control system has technical advantages over existing uses of a single DPPC unit.

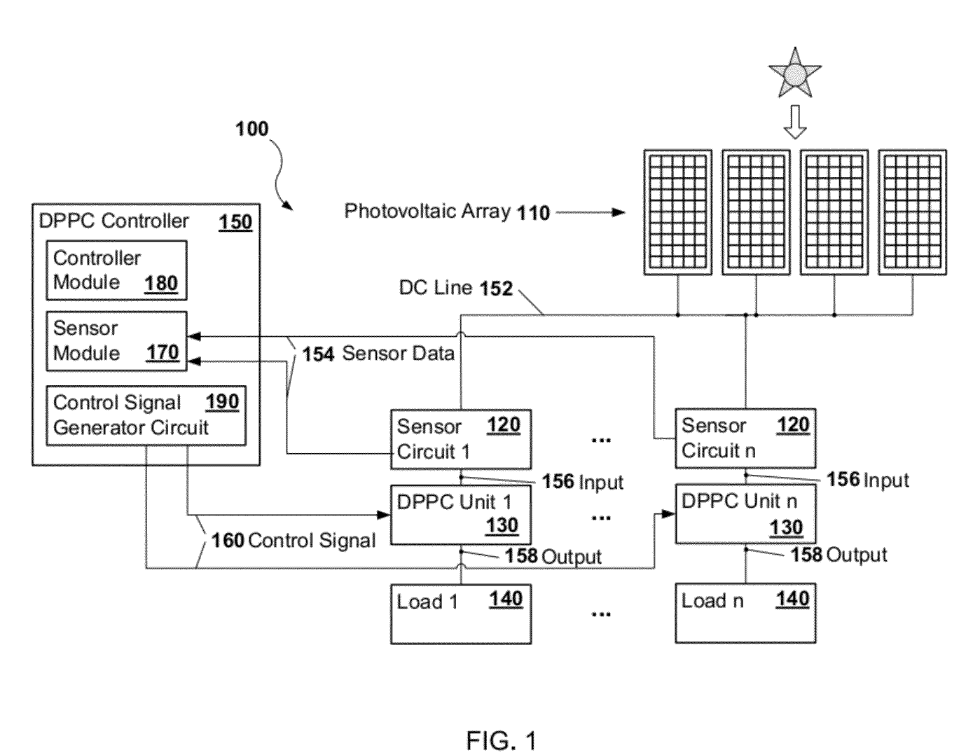

FIG. 1 illustrates a first example of a distributed power point control system 100. The system 100 may include a photovoltaic array 110, multiple sensor circuits 120, multiple DPPC units 130, multiple loads 140, and a DPPC controller 150. The system 100 may include additional, fewer, or different components. For example, the system 100 may include additional sensor circuits between the DPPC units 130 and the loads 140. Alternatively or in addition, the DPPC units 130 may include the sensor circuits 120. The DPPC units 130 may be part of the controller 150. The system 100 may or may not include the loads 140, such as where the system is provided without the loads 140 for later connection to the loads 140. Similarly, the system 100 may or may not include the photovoltaic array 110 as the photovoltaic array 110 may be later connected.

The photovoltaic array 110 may include one or more photovoltaic cells that generate direct current (DC). In one example, the photovoltaic array 110 may include one or more solar panels. The individual solar panels may be connected in series, in parallel, or a combination thereof. Combining the solar panels in series may increase the maximum potential output voltage of the photovoltaic array 110. Combining the solar panels in parallel may increase the maximum potential output current of the photovoltaic array 110. The photovoltaic array 110 may be electrically coupled to a DC line 152 over which the photovoltaic array 110 supplies DC power generated by the photovoltaic cells to the rest of the system 100.

Each one of the sensor circuits 120 may include a component that detects sensor data 154. The sensor data 154 may include, for example, the amount of current flowing into an input of the sensor circuit, the voltage at the input of the sensor circuit, or a combination thereof. In one implementation, the sensor circuit may include a resistor and an operational amplifier that detects a voltage drop over the resistor. The voltage drop may indicate the amount of current flowing through the sensor circuit. Alternatively or in addition, the sensor circuit may include any other type of implementation of a sensor. Each one of the sensor circuits 120 may output the sensor data 154. For example, the sensor data 154 may include the output of the operational amplifier described above that indicates the amount of current flowing through the sensor circuit. Each one of the sensor circuits 120 may include any number of sensors. Alternatively, one sensor circuit 120 is switchably connected to different DPPC units 130 so that sequential measurement may allow fewer sensor circuits 120 than loads 140. The sensor data 154 may include measurement of power, current, voltage, temperature, a duty cycle of a periodic signal, or any other physical characteristic.

Each one of the DPPC units 130 may include a component that controls the relationship between current, voltage, or both at an input 156 of the DPPC unit and current, voltage, or both at an output 158 of the DPPC based on a control signal 160. Thus, each one of the DPPC units 130 may be adjusted with the corresponding control signal 160 so that the combination of the DPPC units 130 present a desired electrical load to the photovoltaic array 110 on the DC line 152 while supplying a suitable output voltage or current to each of the loads 140.

In one implementation, each one of the DPPC units 130 includes a buck-boost converter, switching power converter, or some other type of DC to DC converter. For example, the DPPC unit 130 may include a switching power converter that is controlled by a duty cycle of the control signal 160. The duty cycle, D, may be the fraction of a period of a periodic digital signal during which the periodic digital signal is high, where 0<D<1, or during which the periodic digital signal is low. If the DPPC unit is 100 percent efficient and D is the duty cycle of the control signal 160, then the relationship between the input voltage, Vᵢₙ, across the input 156 of the DPPC unit and the output voltage, Vₒᵤₜ across the output 158 of the DPPC unit may be expressed as Vₒᵤₜ=Vᵢ ×D/(1−D). Alternatively or in addition, the relationship between the input current, Iᵢₙ, received at the input 156 of the DPPC unit and the output current, Iₒᵤₜ, supplied at the output 158 of the DPPC unit may be expressed as Iₒᵤₜ=I_{in l ×(}1−D)/D. Rearranging the equations yields: Vᵢₙ=Vₒᵤₜ×(1−D)/D and Iᵢₙ=Iₒᵤₜ×D/(1−D). The relationship between the inputs of the DPPC units 130 and the outputs may be different in other implementations. For example, in a buck-boost converter (step up or down), Vₒᵤₜ/Vᵢₙ may equal −D/(1−D), but the leading negative sign may be ignored. In a buck converter (step down), Vₒᵤₜ/Vᵢₙ may equal D. In a boost converter (step up), Vₒₙₜ/Vᵢₙ may equal 1/(1−D). In yet another example, Vₒᵤₜ may equal Vᵢₙ×p−0, where p is a configurable value and 0 is a constant offset value.

In a second implementation, each one of the DPPC units 130 may be controlled by a parameter that is digitally encoded in the control signal 160. Alternatively or in addition, any other type of control signal may be used to adjust the relationship between the input current of the DPPC unit and the output current of the DPPC unit, and/or the input voltage and the output voltage of the DPPC unit. For example, each one of the DPPC units 130 may include a digital signal processor to decode the parameter from the control signal 160 and to control a power converter such as a buck-boost converter based on the decoded parameter.

Each one of the loads 140 may include any device or combination of devices that draws power. For example, the loads 140 may include building lights, motors, actuators, fans, display devices, sensors, controllers, power converters, such as voltage to current power converters, battery chargers, batteries, or any other type of electronic device.

The DPPC controller 150 may include a component that generates the control signal 160 for each of the DPPC units 130 such that the current drawn from the DC line 152 by the DPPC units 130 and the voltage across the DC line 152 matches a target current and a target voltage. The target current and the target voltage may be maximum power point or substantially the maximum power point of the photovoltaic array 110. Substantially is used to account for normal variation due to environmental changes and circuit tolerances. In other words, when the current drawn from the DC line 152 and the voltage across the DC line 152 matches the target current and the target voltage, the current and the voltage may be within a suitable tolerance of the target current and the target voltage. In addition, the DPPC controller 150 may be configured to receive the sensor data 154 from the sensor circuits 120. Examples of the DPPC controller 150 include a microcontroller, a central processing unit, a digital signal processor, a digital or analog circuit, or any other device capable of executing logic. For example, the DPPC controller 150 may include a sensor module 170, a controller module 180, and a control signal generator circuit 190. The modules may be separate hardware and/or processes. The sensor module 170 may include a component that receives the sensor data 154. The controller module 180 may include a component that determines the properties of the control signal 160 for each of the DPPC units 130. The DPPC signal generator circuit 190 may include hardware that generates the control signal 160 for each of the DPPC units 130 as directed by the controller module 180.

The DPPC units 130 and the loads 140 may be electrically coupled so that each one of the DPPC units 130 supplies power to a corresponding one of the loads 140. For example, a first one of the DPPC units 130 may power lights on one floor of a building and a second one of the DPPC units 130 may power lights on another floor of the building. Each one of the DPPC units 130 may be powered by the photovoltaic array 110 over the DC line 152. For example, the DPPC units 130 may be electrically coupled in parallel with each other. As a result, the voltage on the DC line 152 may be same as the input voltage of each of the DPPC units 130. Alternatively, two or more of the DPPC units 130 may be electrically coupled in series with each other. Alternatively or in addition, each one of the sensor circuits 120 may be inserted between the DC line 152 and a respective one of the DPPC units 130 as illustrated in FIG. 1, where the voltage on the DC line 152 may be also be substantially the same as the input voltage of each of the DPPC units 130. Alternatively or in addition, each one of the sensor circuits 120 may be inserted between a respective one of the DPPC units 130 and a respective one of the loads 140. Alternatively or in addition, a single sensor circuit may be electrically coupled to the DC line 152 so as to detect the current drawn from the DC line 152 and the voltage across the DC line 152.

During operation of the distributed power point control system 100, the DPPC controller 150 may determine the target current and the target voltage for the photovoltaic array 110. For example, the target current and the target voltage may be a maximum power point of the photovoltaic array 110 or may be a more optimal point of operation given current environmental situation and load requirements.

The DPPC controller 150 may determine the maximum power point or any other target current and voltage pair using any number of techniques. In one example, the DPPC controller 150 may model the I-V curve for the photovoltaic array 110 based on data provided by a manufacturer of the photovoltaic array 110. In a second example, the DPPC controller 150 may calibrate the photovoltaic array 110 during a test mode in order to determine the I-V curve for the photovoltaic array 110. The DPPC controller 150 may enter the test mode during installation, maintenance cycles, or even during normal operation of the system 100. A variable resistance load may be coupled to the photovoltaic array 110 during the test mode. The DPPC controller 150 may vary the resistance of the load, thereby moving the operating point along the I-V curve of the photovoltaic array 110. As the operating point moves, the DPPC controller 150 may measure the current and voltage on the DC line 152, which corresponds to the current and voltage of the operating point on the I-V curve of the photovoltaic array 110.

Alternatively or in addition, the DPPC controller 150 may determine the maximum power point 250 in the test mode. During the test mode, the DPPC controller 150 may provide a particular load such as the variable resistance load or the loads 140 during normal operation. From the sensor data 154, the DPPC controller 150 may determine the power generated by the photovoltaic array 110. The DPPC controller 150 may store the data in a memory for later use. The DPPC controller 150 may direct changes in at least one of the loads 140 so as to vary the overall load on the photovoltaic array 110 and determine whether generated power increases or decreases. The DPPC controller 150 may determine the maximum power point 250 as the point where the power decreases regardless of how the overall load changes. The test mode may be useful to calibrate the system 100 to account for issues such as dirt accumulated on the panels.

Alternatively or in addition, the DPPC controller 150 may download data such as daylight, sunlight, weather, geographic-specific information, manufacturer supplied information, or other information from a data network such as the Internet. The downloaded information may be combined with the calibration data described above to determine the maximum power point, the I-V curve of the photovoltaic array 110, or both for any number of conditions. For example, the I-V curve and maximum power point may change with time of day, time of year, and weather.

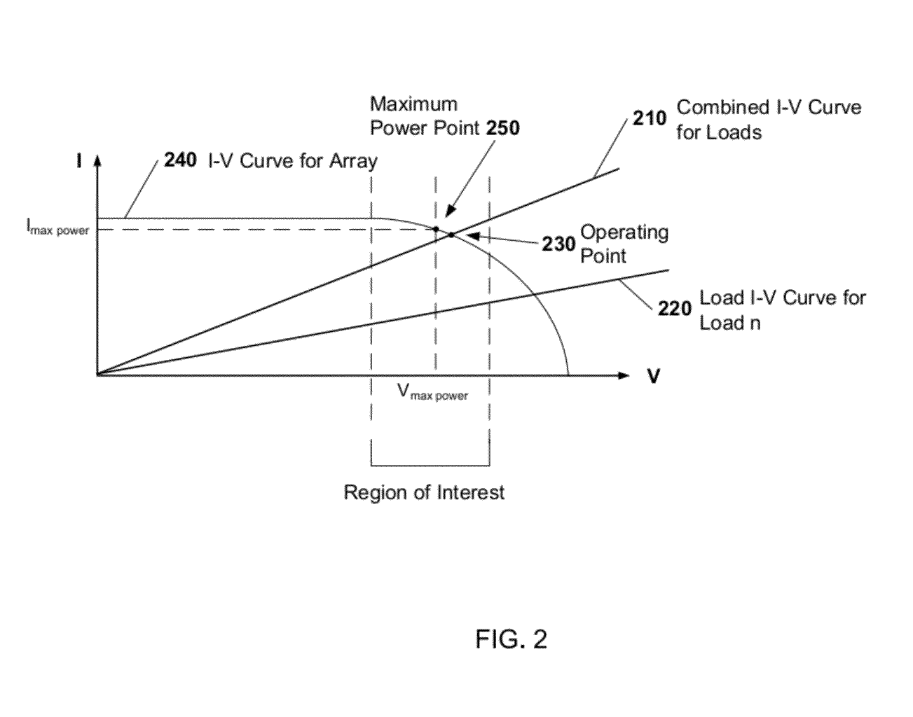

The DPPC controller 150 may determine how to generate the control signal 160 so that the photovoltaic array 110 operates at the maximum power point 250 (I_{max power}, V_{max power}) based on a combined load I-V curve 210. FIG. 2 illustrates an example of the combined load I-V curve 210.

The DPPC controller 150 may determine the combined load I-V curve 210 as follows. Each one of the loads 140 may have a load I-V curve 220. For example, if one of the loads 140 is a resistive load having a resistance R, then the load I-V curve 220 may be a straight line with a slope of 1/R. If the DPPC units 130 are connected in parallel, then the input voltage Vᵢₙ at the input 156 of each of the DPPC units 130 may be the voltage on the DC line 152. As a result, the voltage at the output 158 of each of the DPPC units 130 may be the same for all of the DPPC units 130 if the control signal 160 provided to each of the DPPC units 130 is the same control signal 160. For example, the output voltage, Vₒᵤₜ, of each of the DPPC units 130 may be Vᵢₙ×D/(1−D), where D is the duty cycle of the control signal 160 provided to the DPPC units 130, and Vᵢₙ is the voltage on the DC line 152. Thus, if the DPPC units 130 share the same input voltage and the same control signal 160, then the DPPC units share the same output voltage. If the DPPC units 130 share the same output voltage, then the combined load I-V curve 210 may be formed by adding the load I-V curve 220 of each of loads 140 together. This is because at any particular voltage, the total current drawn by the loads 140 is the sum of the current drawn by each of the loads 140 at that voltage on the load I-V curve 220 for each of the loads 140. For example, the combined load I-V curve 210 for n simple resistive loads, each having a resistance R, may be expressed as I=(n/R)×V, where n indicates the number of the loads 140.

A virtual operating point 230 may be the point at which the combined load I-V curve 210 intersects the I-V curve 240 for the photovoltaic array 110 if the input voltage of the DPPC units 130 were the same as the output voltage of the DPPC units 130. The virtual operating point 230 may not be the same as the maximum power point 250. The DPPC controller 150 may adjust the control signal 160 to compensate for the virtual operating point 230 not being the same as the maximum power point 250.

Accordingly, the DPPC controller 150 may determine how to generate the control signal 160 so that the photovoltaic array 110 operates at the maximum power point 250 (I_{max power} , V_{max power}) based on the combined load I-V curve 210. First, the DPPC controller 150 may determine what load voltage, V_{load}, on the combined load I-V curve 210 results in the loads 140 consuming the maximum power that the photovoltaic array 110 may supply. For example, if the maximum power point (I_{max power}, V_{max power}) is (6 Amps, 17 Volts), then the maximum power supplied by the photovoltaic array is 6×17 Watts, which is 102 Watts. If the combined load I-V curve 210 is expressed as I_{load}=(n/R)×V_{load}, where (n/R) is 2/(20 Ohms), then I_{load}=[1/(10 Ohms)]×V_{load}. Thus, the power consumed by the loads 140 may be written as P=V_{load}×V_{load}=V_{load}²/(10 Ohms). Solving for V_{load} yields V_{load}=sqrt(P×10 Ohms). The power consumed by the devices may equal the power supplied by the photovoltaic array when the DPPC units 130 are ideal components. Therefore, P equals 102 Watts, and V_{load}=sqrt(102×10)=31.9 Volts. Second, the DPPC controller 150 may determine what control signal 160 would cause the DPPC units 130 to generate the load voltage, V_{load}, while the DC line 152 remains at V_{max power}. If Vₒᵤₜ=Vᵢₙ×D/(1−D) for each of the DPPC units 130, then D=Vₒᵤₜ/(Vᵢₙ+Vₒᵤₜ). Solving for D where Vᵢₙ=V_{max power} and Vₒₙₜ=V_{load} results in D=0.65. Thus, the DPPC controller 150 may set the duty cycle of the control signal 160 to 0.65 for all of the DPPC units 130 so that the photovoltaic array 110 operates at the maximum power point 250.

Alternatively or in addition, the DPPC controller 150 may determine what load current, I_{load}, on the combined load I-V curve 210 results in the loads 140 consuming the maximum power that the photovoltaic array 110 generates at the maximum power point 250. Then, from the load current, I_{load}, the DPPC controller 150 may determine what control signal 160 would cause the DPPC units 130 to generate the load current, I_{load}, while the photovoltaic array 110 generates I_{max power}.

In other examples, the DPPC units 130 may not share the same output voltage. For example, the control signal 160 may direct each one of the DPPC units 130 to have a different relationship between the input voltage and the output voltage than the other DPPC units 130. Consequently, if (1) the DPPC units 130 share the same input voltage and (2) the control signal 160 for each of the DPPC units 130 is different than for the other DPPC units 130, then the output voltage of each of the DPPC units 130 may be different than the output voltages of the other DPPC units 130.

If the DPPC units 130 do not share the same output voltage, then the DPPC controller 150 may determine how to generate the control signal 160 based on the load I-V curve 220 for each of the loads 140 individually instead of based on the combined load I-V curve 210. The DPPC controller 150 may determine how to generate the control signal 160 by, for example, solving a system of equations. A solution to a system of equations may be a particular set of values for variables that simultaneously satisfies all of the equations. The system of equations may include equations for the load I-V curves, the relationship between the input and output voltages of each of the DPPC units 130 as a function of a parameter of the control signal 160, the relationship between the input and output currents of each of the DPPC units 130 as a function of a parameter of the control signal 160, and any other relevant equation. The DPPC controller 150 may implement any now known or later discovered technique for solving the system of equations. The particular set of values for the variables satisfying the equations may include one or more parameters to embody in the control signal 160. For example, the values may include values of duty cycles for the control signals supplied to the DPPC units 130.

In one example, the following equations may characterize the photovoltaic array 110:

I=I_{SC}−I_{O}(e^{(V}_{OC}^{/V}_{T}−1)−1)=0 for an open circuit

V_{OC}=V_{T}In(1+I_{SC}/I_{O})

P_{P}=V_{P}[I_{L}−I_{O}(e^{(V}_{P}^{/V}_{T}−1)]

Taking the derivative of the power and setting equal to zero to find the maxima yields:

dP/dV=I_{L}−I_{O}(e^{(V}_{M}^{/V}_{T}⁾−1)−(V_{M}/V_{T})I_{O}e^{(V}_{M}^{/V}_{T}⁾=0

Therefore, at the maximum power point:

I_{M}=I_{L}−I_{O}(e^{(V}_{M}^{/V}_{T}⁾−1)

V_{M}=V_{OC}−V_{T}In(1+V_{M}/V_{T})

where the following values represent the following characteristics of the photovoltaic array 110:
I_{SC}=short circuit current
V_{OC}=open circuit voltage
V_{P}=the panel voltage, which is the voltage across the photovoltaic array
I_{O}=output current
V_{M}=maximum power point voltage
I_{M}=maximum power point voltage
V_{T}=thermal voltage
I_{L}=photocurrent
P_{P}=power generated by the photovoltaic array

In one example where the system 100 includes three DPPC units 130, the following equations may govern certain relationships:

P_{P}=V_{P}(I_{I1}+I_{I2}+I₁₃)

P_{P}=P_{I1}+P_{I2}+P_{I3}

P_{P}=P_{I1}/η₁+P_{I2}/η₂+P_{I3}/ η₃

P_{O1}=V_{O1}=D₁ V_{P} I_{O1}

P_{O2}=V_{O2} I_{O2}=D₂ V_{P} I_{O2}

P_{O3}=V_{O3} I_{O3}=D₃ V_{P} I_{O3}

where:
P_{Ii}=power into i^{th} DPPC unit
P_{Oi}=power out of i^{th} DPPC unit
I_{Ii}=current into i^{th} DPPC unit
I_{Oi}=current out of i^{th} DPPC unit
ηᵢ=efficiency of i^{th} DPPC unit
Dᵢ=duty cycle of control signal to i^{th} DPPC unit
   Substituting and factoring out V_{P} yields:

P_{P}=V_{P}(D₁ I_{O1}/η₁+D₂ I_{O2}/η₂+D₃ I_{O3}/η₃

dP/dV=D₁ I_{O1}/η₁+D₂ I_{O2}/η₂+D₃ I_{O3}/ η₃

therefore, at the maximum power point:

V_{P}[I_{L}−I_{O}(e^{(V}_{P}^{/V}_{T}⁾−1)]=V_{P}(D₁ I_{O1}/η₁+D₂ I_{O2}/η₂+D₃ I_{O3}/ η₃)

I_{L}−I_{O}(e^{(V}_{P}^{/V}_{T}⁾−1)=D_{1 I}_{O1}/η₁+D₂ I_{O2}/η₂+D₃ I_{O3}/η₃

I_{L}−(D₁ I_{O1}/η₁+D₂ I_{O2}/η₂+D₃ I_{O3}/η₃)(e^{(V}_{P}^{/V}_{T}⁾₋₁)−(V_{P}/V_{T})(D₁ I_{O1}/η₁+D₂ I_{O2}/η₂+D₃ I_{O3}/η₃) e^{(V}_{P}^{/V}_{T}⁾=0

If the three DPPC units 130 each include a buck converter, then the following may be true:

D₁=V_{O1}/V_{P}

D₂=V_{O2}/V_{P}

D₃=V_{O3}/V_{P}

Thus, the relationships been Dᵢ and V_{Oi} are known and may be controlled by the DPPC controller 150. Accordingly, the system of equations in the example where the system 100 includes three DPPC units 130 may include the following equations:

I_{L}−(D₁ I_{O1}/η₁+D₂ I_{O2}/η₂+D₃ I_{O3}/η₃)(e^{(V}_{P}^{/V}_{T}⁾−1)−(V_{P}/V_{T})(D₁ I_{O1}/η₁+D₂ I_{O2}/η₂+D₃ I_{O3}/η₃)e^{(V}_{P}^{/V}_{T}⁾=0

D₁=V_{O1}/V_{P}

D₂=V_{O2}/V_{P}

D₃=V_{O3}/V_{P}

The DPPC units 130 may not share the same input voltage. For example, there may be voltage drops between the photovoltaic array 110 and the input 156 of the DPPC units 130 that vary depending on the DPPC unit. The voltage drops may be due to the interconnect arrangement between the photovoltaic array 110 and the DPPC units 130. For example, the photovoltaic array 110 may be on the roof of a ten-story building. Each of the DPPC units 130 may be on a corresponding floor of the building and power lights on the floor. The length of the wiring from the photovoltaic array 110 to the DPPC units 130 may depend on which floor the corresponding DPPC unit is located. Accordingly, each one of the DPPC units 130 may receive a different voltage at the input 156 of the DPPC unit than the other DPPC units 130. For example, the voltage at the input 156 of the DPPC unit on the first floor may be lower than at the input 156 of the DPPC unit on the tenth floor. The DPPC controller 150 may compensate for the variances in the input voltages by adjusting the control signals. For example, the DPPC controller 150 may increase the duty cycle of the control signal 160 to the DPPC unit on the first floor in order to maintain the same voltage at the output 158 of the DPPC units 130.

The DPPC controller 150 may simplify or otherwise modify the equations. The DPPC controller 150 may have knowledge of the loads 140 that affects the equations. The loads 140 may preferably be supplied at a particular voltage, within a range of voltages, at a particular current, or within a range of currents. For example, one of the loads 140 may include a DC to DC converter that relies on having an input voltage ranging from 60 to 90 Volts. Alternatively or in addition, the DPPC controller 150 may include or modify equations in the system of equations so that power is distributed evenly across the loads 140 or concentrated in a subset of the loads 140. For example, a water pump may consume a wide range of power at a wide range of current and voltages, while a DC to DC converter may consume a relatively constant amount of power at a relatively constant voltage. Alternatively or in addition, the DPPC controller 150 may bias the solution to the system of equations. For example, the DPPC controller 150 may prefer voltages at the higher end of a range of potential voltages to supply to the loads 140. For example, if one of the loads 140 includes a DC to DC converter that powers electrical devices, then a higher load voltage may translate into lower power loss in the DC to DC converter. For a particular amount of power that the DC to DC converter delivers to the electrical devices, the amount of current flowing through the DC to DC converter may be lower at a higher input voltage to the converter than at a lower input voltage, thus resulting in a lower power loss in the DC to DC converter.

The DPPC controller 150 may be unable to find a solution to the system of equations. For example, the loads 140 may be unable to draw all of the power that the photovoltaic array 110 may be capable of generating at the maximum power point 250. The DPPC controller 150 may decrease the target current, voltage, or both. Alternatively or in addition, one or more batteries may be electrically coupled to the output 158 of one or more of the DPPC units 130 in addition to the corresponding loads 140. Thus, the batteries may be charged from the excess power generated by the photovoltaic array 110. Alternatively or in addition, individual panels or cells in the photovoltaic array 110 may be shut down to lower the overall output of the photovoltaic array 110. Alternatively or in addition, a resistive load may be switched in to draw off the excess power. Alternatively or in addition, one or more of the loads 140 may include a battery. The DPPC controller 150 may increase or decrease the voltage delivered to the battery so that the photovoltaic array 110 operates at the target current and voltage. The DPPC controller 150 may be restricted in how much the control signal 160 may vary for one or more of the DPPC units 130 due to voltage or current requirements of the corresponding loads 140. However, the DPPC controller 150 may vary the control signal 160 to the DPPC unit supplying the battery as needed in order to compensate for the restriction on the control signal 160 transmitted to the other DPPC units 130.

Alternatively, the loads 140 may draw more power than the photovoltaic array 110 may be capable of generating. One or more batteries electrically coupled to the output 158 of one or more of the DPPC units 130 may provide extra power demanded by the loads 140. Alternatively or in addition, an AC (alternating current) converter may supply the extra power demanded by the loads 140.

As described in more detail below, the DPPC controller 150 may have knowledge of the loads 140 and, based on that knowledge, direct or suggest adjustments in the loads 140 so that the photovoltaic array 110 may operate at the maximum power point 250 or at some other target current and voltage. For example, the DPPC controller 150 may cause one or more devices included in the loads 140 to draw power from another source, to reduce power, to shut off, or take any number of actions to reduce or increase power consumption.

Consider an example in which the system 100 is installed in a three-story building. The system may include four DPPC units 130. Three of the DPPC units 130 may power lights on corresponding floors of the three-story building. One of the DPPC units 130 may power a battery. The DPPC units 130 may each include a buck regulator where V_{Oi}/V_{Ii} , may equal Dᵢ if efficiency is ignored. The maximum power point, (I_{M}, V_{M}), of the photovoltaic array 110 may be (110 Amps, 100 Volts). The DPPC controller 150 may receive V_{Oi} and I_{Oi} for each of the DPPC units 130 in the sensor data 154. The DPPC controller 150 may determine P_{Oi} as the multiplicative product of V_{Oi o}and I_{Oi}. Neglecting efficiency, the DPPC controller 150 may solve the system of equations as follows:

1^{st} floor DPPC unit
V_{O1}=75 Volts I_{O1}=20 Amps

Solving yields,
P_{O1}=1500 Watts I_{I1}=15 Amps D₁=0.75

2^{nd} floor DPPC unit
V_{O2}=80 Volts I_{O2}=25 Amps

Solving yields,
P_{O2}=2000 Watts I_{I2}=20 Amps D₂=0.8

3^{rd} floor DPPC unit
V_{O3}=90 Volts I_{O3}=50 Amps

Solving yields,
P_{O3}=4500 Watts I_{I3}=45 Amps D₃=0.9

Battery DPPC unit
V_{OB}=15 Volts I_{OB}=200 Amps

Solving yields, P_{OB}=3000 Watts I_{IB}=30 Amps D_{B}=0.15

I_{M}=110 Amps=I_{I1}+I_{I2}+I_{I3}+I_{IB}

From the equations and determined values described immediately above, the DPPC controller 150 may determine that, with the control signals having the determined duty cycles, D₁, D₂, D₃, and D_{B}, respectively, the operating point 230 is at the maximum power point 250 of the photovoltaic array 110. If the current drawn by the first floor DPPC unit drops to 13.3 Amps from 20 Amps, for example, then the DPPC controller 150 may apply a policy of charging the battery with the excess power. In other words, the DPPC controller 150 may adjust D_{B} in order to obtain a suitable V_{OB} and I_{OB}. If the first floor DPPC unit powers a power converter, the power converter may cause the output voltage of the first floor DPPC unit to remain substantially constant despite the drop in current consumption. Therefore, V_{Ii} may remain at 100 Volts for the four DPPC units 130. The DPPC controller 150 may determine a suitable I_{IB} by solving I_{M}−I_{I1}−I_{I2}−I_{I3}=I_{IB}. For example, 100 Amps−10 Amps−20 Amps−45 Amps=35 Amps. F_{IB}=I_{iB}×V_{IB}=35 Amps×100 Volts=3500 Watts. The DPPC controller 150 may determine I_{OB} and V_{OB} from a point on the load I-V curve 220 for the battery at which the product of I_{OB} and V_{OB} equals the determined value for F_{IB}. For example, I_{OB} and V_{OB} may equal 225 Amps and 15.56 Volts, respectively. Accordingly, the DPPC controller 150 may determine D_{B} to be 0.1556 from V_{IB} and V_{OB}. Thus, in response to the current drawn by the first floor DPPC unit dropping to 13.3 Amps, the DPPC controller 150 may set D_{B} to 0.1556 and keep the photovoltaic array 110 operating at the maximum power point 250.

The load I-V curve 220 illustrated in FIG. 2 is a straight line segment that corresponds to a simple resistive load. However, the load I-V curve 220 for one type of load may be substantially different from another type of load. The load I-V curve 220 may be a discontinuous function. Because any one of the loads 140 may include multiple devices electrically coupled together, the load I-V curve 220 may be based on the load I-V curves of the multiple devices.

Referring back to FIG. 1, the sensor data 154 and the control signal 160 between the DPPC controller 150 and the sensor circuits 120 and DPPC units 130, respectively, form a feedback loop. The DPPC controller 150 may determine the target current and the target voltage for the photovoltaic array 110 as the maximum or target power point. The DPPC controller 150 may determine how to generate the control signal 160 based on the target current and the target voltage. The DPPC controller 150 may generate the control signal 160 accordingly. The DPPC controller 150 may receive the sensor data 154 after generating the control signal 160. Based on the sensor data 154 received, the DPPC controller 150 may alter the control signal 160 to one or more of the DPPC units 130. For example, the DPPC controller 150 may determine from the sensor data 154 that the photovoltaic array 110 is not yet operating at the maximum power point 250. Not operating at the maximum power point 250 may be due to inaccuracies in the models of the loads 140, of the photovoltaic array 110, of the DPPC units 130, changes in the photovoltaic array 110, or any combination thereof. To compensate, the DPPC controller 150 may adjust the control signal 160 to one or more of the DPPC units 130 in order to appropriately increase or decrease the target current drawn from the DC line 152 or the target voltage across the DC line 152. For at least the reasons provided above, the target current and the target voltage for the photovoltaic array 110 may vary over time and may not necessarily correspond to the maximum power point 250.

Alternatively or in addition, the DPPC controller 150 may alter the control signal 160 and determine from the sensor data 154 whether the power generated by the photovoltaic array 110 increases or decreases in response to the alteration. Thus, the DPPC controller 150 may track the maximum power point 250 or some other target power point as the maximum power point 250 changes over time, the loads 140 change over time, or any combination thereof.

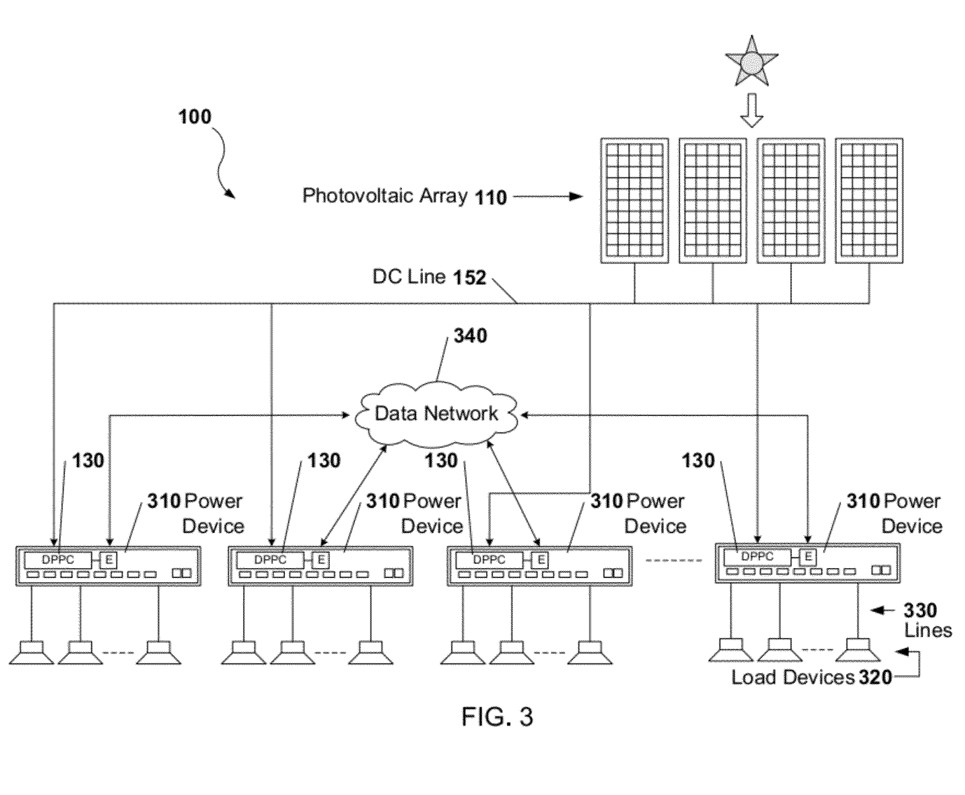

FIG. 3 illustrates a second example of the distributed power point control system 100. The system 100 may include the photovoltaic array 110, the DC line 152, power devices 310, and load devices 320 that are powered by the power devices 310.

Each one of the power devices 310 may provide a DC (direct current) power signal over multiple lines 330 to multiple load devices 320. The load devices 320 may include light fixtures, sensors, motors, display screens, batteries, or any other device that consumes electrical power. The load devices 320 may be powered by the DC power signal provided by the power device 310. Each one of the load devices 320 may receive the DC power signal over a different line than the other load devices 320. Alternatively, the DC power signal of one of the lines 340 may power two or more of the load devices 320. Alternatively or in addition, one or more of the load devices 320 may be powered by two or more of the lines 340. The DC power signal may be pulse-width modulated (PWM) signal, an amplitude modulated signal, or any other type of signal. Each one of the power devices 310 may receive power from the photovoltaic array 110 and transfer the power to the load devices 320. In addition, each one of the power devices 310 may receive power from an AC power grid and transfer the power to the load devices 320. Each one of the power devices 310 may include a corresponding one or more of the DPPC units 130. Each one of the power devices 310 may include a component, such as a voltage converter, that presents the load devices 320 as one of the loads 140 to the DPPC unit. Each one of the power devices 310 may include one or more sensors, such as one of the sensor circuits 120 illustrated in FIG. 1. Each one of the power devices 310 may include, for example, the power device described in U.S. patent application Ser. No. 12/790,038, entitled “SMART POWER DEVICE,” filed May 28, 2010.

The power devices 310 may communicate with each other over a data network 340. The data network 340 may be a local area network (LAN), a wireless local area network (WLAN), a personal area network (PAN), a wide area network (WAN), the Internet, Broadband over Power Line (BPL), any other now known or later developed communications network, or any combination thereof. For example, the data network 340 may include a wireless router that is in communication with the power devices 310 over an Ethernet cable or that is integrated within the power device or an adjacent communication device. The data network 340 may include any number of devices, such as network switches, network hubs, routers, Ethernet switches, or any other type of network device.

During operation of the system 100, the power devices 310 may communicate with each other over the data network 340. In one example, the power devices 310 that include the DPPC units 130 may discover each other on the data network 340 using any service discovery protocol or any other network protocol that facilitates automatic detection of devices and services on the data network 340. Alternatively or in addition, the power devices 310 may negotiate with each other to determine which one of the power devices 310 is a master power device. The master power device may act as the DPPC controller 150. The power devices 310 may use any protocol to determine the master power device from among the power devices 310. Alternatively or in addition, one of the power devices 310 may be manually configured to be the master power device.

The master power device may receive the sensor data 154 from the other power devices 310 over the data network 340. The master power device may transmit the control signal 160 over the data network 340 to one or more of the power devices 310. For example, the master power device may transmit a data packet that includes a numerical representation of a duty cycle to the power devices 310. Alternatively or in addition, the master power device may transmit the control signal 160 to one or more of the power devices 310 over one of the lines 330 where the DPPC units 130 are included in the load devices 320 of the master power device. Therefore, the power devices 310 may track the maximum or target power point 250 of the photovoltaic array 110 as described in connection with FIG. 1.

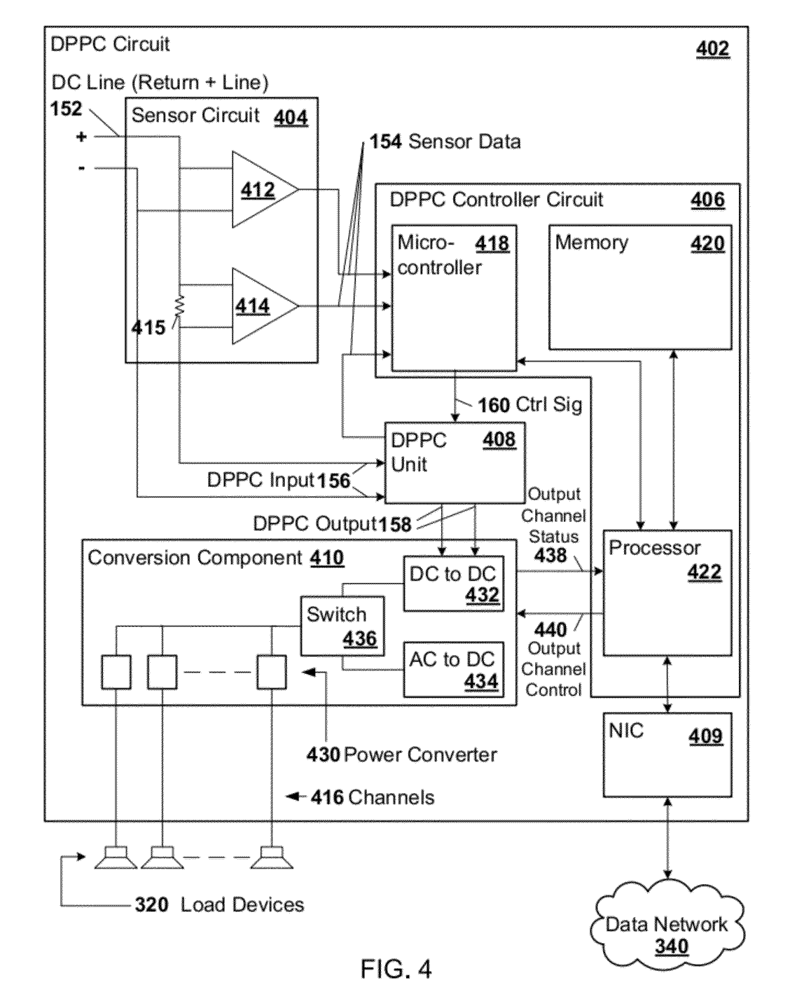

FIG. 4 illustrates an example of a DPPC circuit 402. The DPPC circuit 402 may be included in a node in the distributed power point control system 100. For example, each one of the power devices 310 may be a node in the system 100. The DPPC circuit 402 may implement the features of the distributed power point control system 100 in each of the nodes.

The DPPC circuit 402 may include a sensor circuit 404, a DPPC controller circuit 406, a DPPC unit 408, a network controller 409, and an output stage conversion component 410. The DPPC circuit 402 may include additional, fewer, or different components. For example, the DPPC circuit 402 may not include the output stage conversion component 410 and the network interface controller 409.

The DPPC unit 408 may include at least one of the DPPC units 130 described above. The sensor circuit 404 may include at least one of the sensor circuits 120 described above. In the example illustrated in FIG. 4, the sensor circuit 404 includes an operational amplifier 412 to measure voltage across the input 156 of the DPPC unit 408 and an operational amplifier 414 in combination with a resistive element 415 to measure current that flows into the input 156 of the DPPC unit 408.

The network interface controller (NIC) 409 may include hardware or a combination of hardware and software that enables communication over the data network 340. The NIC 409 may provide physical access to the data network 340 and provide a low-level addressing system through use of, for example, Media Access Control (MAC) addresses. The NIC 409 may include a network card that is installed inside a computer or other device. Alternatively or in addition, the NIC 409 may include an embedded component as part of a circuit board, a computer mother board, an expansion card, a USB (universal serial bus) device, or as part of any other hardware.

The conversion component 410 may include hardware or a combination of hardware and software that converts power received from a source, such as from the output 158 of the DPPC unit 409, to power delivered to one or more channels 416. For example, each of the channels 416 may power a corresponding one of the load devices 320. In one implementation, the conversion component 410 may include a power converter 430 for each of the channels 416, a DC to DC converter 432, an AC to DC converter 434, and a switch 436. The conversion component 410 may include additional, fewer, or different components. In one example, the conversion component may not include the DC to DC converter 432. In a second example, the conversion component 410 may include additional hardware or a combination of hardware and software that communicates with the load devices 320.

The power converter 430 may include any device that generates an output DC signal from a DC signal, such as a DC to DC converter or a switching-mode power supply (SMPS). The DC to DC converter 432 may include any electronic circuit that converts a source of direct current from one voltage level to another or that otherwise regulates an output voltage or current from an input. The AC to DC converter 434 may convert an AC signal from the utility grid to a DC output signal. The switch 436 may include any device that switches between one power source and another. For example, the switch 436 may include one or more ORing diodes.

The DPPC controller circuit 406 may implement the features of the DPPC controller 150 described above. Alternatively or in addition, the DPPC controller circuit 406 in one node may interoperate with the DPPC controller 150 embodied in a device physically separate from DPPC circuit 402. For example, the DPPC controller circuit 406 in one node of the distributed power point control system 100 may interoperate with the DPPC controller 150 embodied in a different one of the nodes. The DPPC controller circuit 406 may include a microcontroller 418, a memory 420, and a processor 422. The DPPC controller circuit 406 may include fewer, additional, or different components. For example, the DPPC controller circuit 406 may include just the microcontroller 418. Alternatively, the DPPC controller circuit 406 may include just the processor 422 and the memory 420. In one example, the DPPC controller circuit 406 may include the NIC 409. In a second example, the DPPC controller circuit 406 may include a dedicated analog or analog/digital controller with control pins that control the control signal 160 instead of including the microcontroller 418.

The microcontroller 418 may implement the features of the DPPC controller 140. Alternatively or in addition, the microcontroller 418 may interoperate with the DPPC controller 150 embodied in a device physically separate from DPPC circuit 402, such as in a remote node in the distributed power point control system 100. The microcontroller 418 may include a computer on a single integrated circuit that includes a processor core, memory, and programmable input/output lines. The microcontroller 418 may include program memory such as NOR (not OR) flash or OTP (one-time programmable) ROM in addition to RAM (random access memory. The microcontroller 418 may communicate with the NIC 409 either through a direct connection with an appropriate network driver or through the processor 422.

The memory 420 may be any data storage device or combination of data storage devices. The memory 420 may include non-volatile and/or volatile memory, such as a random access memory (RAM), a read-only memory (ROM), an erasable programmable read-only memory (EPROM), flash memory, or any other type of computer readable memory. Alternatively or in addition, the memory 420 may include an optical, magnetic (hard-drive) or any other form of data storage device.

The processor 422 may be in communication with the memory 420. The processor 422 may also be in communication with additional components, such as the microcontroller 418 and the NIC 409. The processor 422 may include a general processor, central processing unit, server, application specific integrated circuit (ASIC), digital signal processor, field programmable gate array (FPGA), digital circuit, analog circuit, or combinations thereof. The processor 422 may include one or more components that execute computer executable instructions or computer code embodied in the memory 420 or in other memory to implement the features of the DPPC controller 150, to interoperate with the DPPC controller 150 embodied in a device physically separate from DPPC circuit 402, to control the signals generated on the channels 416, or any combination thereof. For example, the microcontroller 418 and the processor 422 may each implement part of the features of the DPPC circuit 402.

During operation of the DPPC circuit 402, the DPPC circuit 402 may receive power from the photovoltaic array 110 over the DC line 152 that the DPPC circuit 402 is to supply to the load devices 320. The DPPC unit 408 may receive the power directly from the DC line 152, indirectly through the sensor circuit 404, or through any other component. The DPPC unit 408 may receive the control signal 160 from the DPPC controller circuit 406. The output 158 of the DPPC unit 408 may supply the power to the conversion component 410. The conversion component 410 may power the load devices 320.

The DPPC controller circuit 406 may receive the sensor data 154, such as the measured voltage and current, from the sensor circuit 404. Alternatively or in addition, the DPPC controller circuit 406 may receive at least a portion of the sensor data 154 from the DPPC unit 408. For example, the DPPC controller circuit 406 may receive information about the operation of the DPPC unit 408, such as the duty cycle of the control signal 160, the voltage at the input 156 of the DPPC unit 40, the voltage at the output 158 of the DPPC unit 40, the current received at the input 156 of DPPC unit 40, and the current supplied at the output 158 of the DPPC unit 40. Alternatively or in addition, the DPPC controller circuit 406 may receive the sensor data 154 generated by one or more of the sensor circuits 120 in other DPPC circuits in the system 100. For example, the DPPC controller circuit 406 may receive the sensor data 154 embodied in data packets. The data packets may be received by the NIC 409 from the data network 340.

The DPPC controller circuit 406 may generate the control signal 160 as described above in connection with the DPPC controller 150. For example, the DPPC controller circuit 406 may generate the control signal 160 for the DPPC unit 408 with the microcontroller 418. In one example, the DPPC controller circuit 406 may generate the control signal 160 for the other DPPC units 130 in the system 100 by transmitting data packets over the data network 340 to one or more other DPPC circuits. In a second example, the DPPC controller circuit 406 may generate the control signal 160 for other DPPC units 130 in the system 100 by generating a suitable signal on the channels 416 electrically coupled to the other DPPC units 130.

Accordingly, the DPPC controller circuit 406 may track the maximum power point 250 or otherwise control the operating point as described above in connection with DPPC controller 150. Although the DC to DC converter 432 may restrict the voltage at the output 158 of the DPPC unit 408 to a predetermined voltage range, the current flowing into the DC to DC converter 432 may increase or decrease based on the current demanded by the load devices 320. If the load devices 320 demand more current from the DC to DC converter 432 than the photovoltaic array 110 is able to provide through the DPPC unit 408, then the switch 436 may draw the extra current or all of the current from another source, such as the AC to DC converter 434. Similarly, if the power output of the photovoltaic array 110 increases as a result of increased light, adjustments to the control signal 160 for each of the DPPC units 130, or some other event, then the load devices 320 may draw more power from the DC to DC converter 432 and less from other sources such as the AC to DC converter 434.

Alternatively or in addition, the DPPC controller circuit 406 may adjust a load profile of the DPPC unit 408 to optimize power usage. For example, the DPPC controller circuit 406 may reduce light levels or turn off unneeded lights as determined by policies configured in the memory 420. The load profile may include any characterization of the load devices 320 or the power drawn by the load devices 320.

To alter the load profile, the processor 422 in the DPPC controller circuit 406 may control the power converter 430 for each corresponding one of the channels 416. The processor 422 may also communicate with the load devices 320 bi-directionally or in one direction. In particular, the processor 422 may receive information related to the channels 416 as output channel status information 438 from the conversion component 410. The processor 422 may control the power delivered to the load devices 320 by transmitting output channel control information 440 to the conversion component 410. Therefore, the processor 422 may gather information about the load devices 320, control the amount of power delivered to any of the load devices 320, and even stop powering one or more of the load devices 320.

For example, if the maximum power point 250 of the photovoltaic array 110 drops, the DPPC controller circuit 406 may determine whether any of the load devices 320 may be shut off or receive a reduced amount of power. If so, then the DPPC controller circuit 406 may transmit the output channel control information 440 to the conversion component 410 directing the conversion component 410 to shut off or reduce power to one or more of the load devices 320. The DPPC controller circuit 406 may evaluate the load profiles of all of the DPPC units 130 in the system 100 in order to determine which of the load devices 320 would best be affected.

Conversely, if the maximum power point 250 rises, then the DPPC controller circuit 406 may determine whether any of the load devices 320 may be turned on or receive an increased amount of power. If so, then the DPPC controller circuit 406 may transmit the output channel control information 440 to the conversion component 410 directing the conversion component 410 to turn on or increase power to one or more of the load devices 320. Accordingly, the DPPC controller circuit 406 may alter the load profile of any of the DPPC units 130 in addition to, or in combination with, the control signal 160 to the DPPC units 130 in the system 100 in order to optimize the power drawn from the photovoltaic array 110.

Thus, the power devices 310 that include the DPPC circuit 402 may be clustered. The power devices 310 may automatically discover each other on the data network 340 and select the master power device. For example, the processor 422 in each one of the power devices 310 may communicate with the processor 422 in the other power devices 310 over the data network 340. The power devices 310 other than the master power device may be slave power devices. In one example, a server computer (not shown) that is separate from the power devices 310 may negotiate with the power devices 310 and become a master node. The master node, whether the server computer or the master power device, may gather information from all of the slave nodes that indicates the power used by each of the slave nodes. With that information, the master node may direct the DPPC controller circuit 406 in one or more of the power devices 310 to change a duty cycle of the control signal 160. Alternatively or in addition, the master node may direct the processor 422 of one or more of the slave nodes to change the load profile of the respective slave nodes. Thus, the master node may, from the information received about the distributed DPPC units 130, determine the maximum power point 250 of the photovoltaic array 110, and track the maximum power point 250.

The distributed power point control system 100 may compensate for the photovoltaic array 110 being sensitive to ripple and transient currents. By staggering the phase of the control signal 160, the DPPC controller 150 may minimize ripple and transient currents.

For example, the DPPC controller 150 may adjust the phase of each of the control signals by 360/n degrees, where n is the number of the DPPC units 130, so that none of the control signals is in phase with each other. Alternatively or in addition, the DPPC controller 150 may adjust or set the control signals based on pulse width. The pulse width of the control signal 160 may be the same for all the DPPC units 130, but in other examples, the pulse width of the control signal 160 may be different for different DPPC units 130. If the pulse width of the signals varies from control signal to control signal, then the phases of the control signal may be adjusted by values other than 360/n.

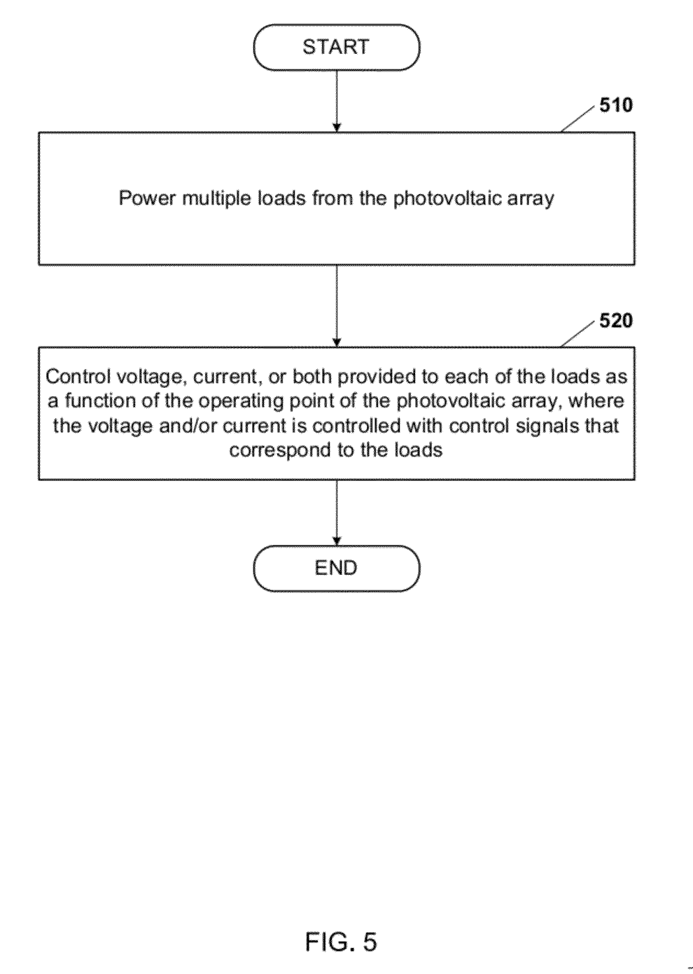

FIG. 5 illustrates a first example flow diagram of the logic of the system 100. The logic may include additional, different, or fewer operations. The operations may be executed in a different order than illustrated in FIG. 5.

The logic may begin by powering the loads 140 from the photovoltaic array 110 (510). For example, the DPPC units 130 may transfer power received from the photovoltaic array 110 to the loads 140.

The DPPC controller 150 may be in communication with the DPPC units 130. In one example, one of the power devices 310 may include the DPPC controller 150 and one of the DPPC units 130. The DPPC controller 150 may transmit data packets to the other power devices 310 that include the remaining DPPC units 130.

The logic may continue by controlling voltage, current, or both, provided to each of the loads as a function of the operating point 230 of the photovoltaic array 110 (520). For example, the DPPC controller 150 may generate a control signal 160 for each respective one of the DPPC units 130, where the control signal 160 indicates a relationship between an input voltage and an output voltage of each respective one of the DPPC units 130 at which the single photovoltaic array 110 generates a target current at a target voltage as the DPPC units 130 power the loads 140. The target current at the target voltage may correspond to the current and voltage at the maximum power point 250 of the single photovoltaic array 110. In one example, the target current and the target voltage may be determined from solving the system of equations as described above. Alternatively or in addition, the target current and the target voltage may be determined by varying the control signal 160 and determining from sensor data 154 that the power generated by the single photovoltaic array 110 decreases regardless of whether a parameter of the control signal 160 is increased or decreased. In other words, if the parameter of the control signal 160 is appropriately set so that the operating point 230 is at the maximum power point 250, then increasing or decreasing the parameter would decrease the power generated by the photovoltaic array 110. Thus, the target current and the target voltage may be determined as the current generated by the photovoltaic array 110 and the voltage across the photovoltaic array 110 when the sensor data 154 indicates further adjustment of the control signal 160 decreases the power generated by the single photovoltaic array 110.

The logic may end, for example, by receiving the sensor data 154 indicating an amount of power generated by the single photovoltaic array 110, and adjusting the control signal 160 so that the single photovoltaic array 110 continues to generate the target current at the target voltage.

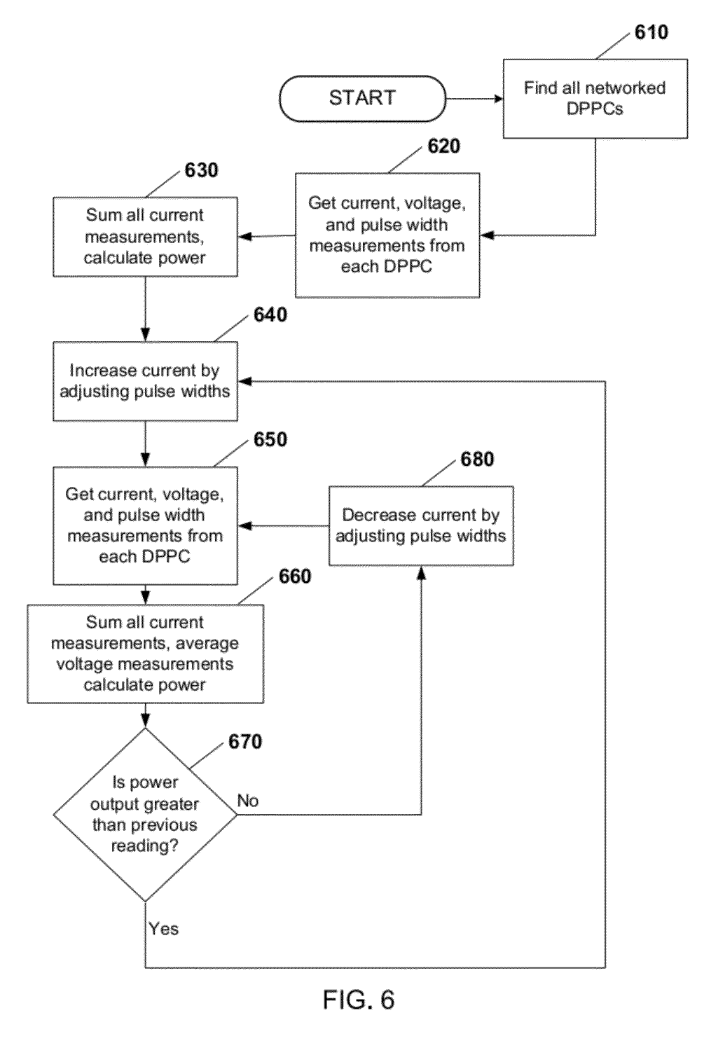

FIG. 6 illustrates a second example flow diagram of the logic of the system 100. The logic may include additional, different, or fewer operations. The operations may be executed in a different order than illustrated in FIG. 6.

The logic may begin by finding all of the DPPC units 130 on the data network 340 (610). The logic may continue by receiving current, voltage, and pulse width measurements from the sensor circuits 120 electrically coupled to or included in the DPPC units 130 (620). The pulse width measurements may indicate the duty cycles of the control signals currently received by the DPPC units 130. The current measurements may be summed and the power received or supplied by the DPPC units 130 may be calculated (630).

The current through the DPPC units 130 may be increased by adjusting the control signal 160 to at least one of the DPPC units 130 (640). For example, the pulse width of the control signal 160 may be adjusted to alter the duty cycle of the control signal 160.

The logic may continue by receiving current, voltage, and pulse width measurements from the sensor circuits 120 again (650). In one example, the current measurements may be summed, the voltages averaged, and the power received or supplied by the DPPC units 130 may be calculated as a product of the summed current and averaged voltages (660).

A determination may be made whether the power received or supplied by the DPPC units 130 is greater than previously (670). If not, then the logic may continue by re-adjusting the control signal 160 to at least one of the DPPC units 130 (680) to decrease current through the MPP units 130. After re-adjusting the control signal 160, the process may return to receiving current, voltage, and pulse width measurements from the sensor circuits 120 again (650).

If, however, the power received or supplied by the DPPC units 130 is greater than previously determined, then the logic may continue by returning to the operation of causing current through the DPPC units 130 to increase by adjusting the control signal 160 to at least one of the DPPC units 130 (640). The logic may repeat the process indefinitely until some event, such as a system shutdown event. Alternatively, the logic may cease to further adjust the control signal 160.

The distributed power point control system 100 may be implemented in many different ways. For example, the DPPC circuit 402 may implement the logic of the features described above as programs and processes stored in the memory 420. The programs and processes may be executed by the processor 422. As examples, the memory 420 may include modules, such as the controller module 180 and the sensor module 170 implemented as programs and processes. Alternatively or in addition, one or more of the modules may be implemented as hardware, such as a field programmable gate array (FPGA) or any other digital or analog circuit.

The system 100 may be implemented with additional, different, or fewer entities. As one example, the system 100 may include just the power devices 310, just two or more circuits like the DPPC circuit 402, or just the DPPC controller 150. As another example, the control signal generator circuit 190 of the DPPC controller 150 may include just the microcontroller 418. Alternatively or in addition, the entire DPPC controller 150 may just include the microcontroller 418. Alternatively, the control signal generator circuit 190 may include a module in the memory 420, the processor 422, and the network interface controller 409. In still another example, the DPPC units 130 may include a memory and a processor, such as the memory 420 and the processor 422 in the DPPC controller circuit 406. The processors, such as the processor 422 in the DPPC controller circuit 406, may be implemented as a microprocessor, a microcontroller, a digital signal processor (DSP), an application specific integrated circuit (ASIC), discrete logic, or a combination of other types of circuits or logic. The processors may include a general processor, central processing unit, server, application specific integrated circuit (ASIC), digital signal processor, field programmable gate array (FPGA), digital circuit, analog circuit, or combinations thereof. As another example, memories such as the memory 420 of the DPPC controller circuit 406 may include a non-volatile and/or volatile memory, such as a random access memory (RAM), a read-only memory (ROM), an erasable programmable read-only memory (EPROM), flash memory, any other type of memory now known or later discovered, or any combination thereof. The memory 420 may include an optical, magnetic (hard-drive) or any other form of data storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may be implemented with different types of data structures such as linked lists, hash tables, or implicit storage mechanisms. Logic, such as programs or circuitry, may be combined or split among multiple programs or circuits, distributed across several memories and processors, and may be implemented in a library, such as a shared library (e.g., a dynamic link library (DLL)). The DLL, for example, may store code that solves systems of equations.

The processors may be one or more devices operable to execute computer executable instructions or computer code embodied in memory to perform the features of the DPPC circuit 402. The computer code may include instructions executable with one or more of the processors. The computer code may be written in any computer language now known or later discovered, such as C++, C#, Java, Pascal, Visual Basic, Perl, HyperText Markup Language (HTML), JavaScript, assembly language, shell script, or any combination thereof. The computer code may include source code and/or compiled code.

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer-readable storage media, for example, secondary storage devices such as hard disks, floppy disks, and CD-ROMs; or other forms of ROM or RAM either currently known or later developed. The computer-readable storage media may be non-transitory computer-readable media, which includes CD-ROMs, volatile or non-volatile memory such as ROM and RAM, or any other suitable storage device. Moreover, the various modules and functionality are but one example of such functionality and any other configurations encompassing similar functionality are possible.

Furthermore, although specific components of innovations were described, methods, systems, and articles of manufacture consistent with the innovation may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program. The components may be resident on separate hardware, such as separate removable circuit boards, or share common hardware, such as a same memory and processor for implementing instructions from the memory. Programs may be parts of a single program, separate programs, or distributed across several memories and processors.

The respective logic, software or instructions for implementing the processes, methods and/or techniques discussed above may be provided on or distributed across computer-readable media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A system to control power generated by a photovoltaic array, the system comprising:
a plurality of distributed power point control units configured to receive power from the photovoltaic array, wherein each one of the distributed power point control units is configured to supply a portion of the power received from the photovoltaic array to a corresponding one of a plurality of loads; and
a distributed power point control controller in communication with the distributed power point control units, wherein the distributed power point control controller is configured to generate a control signal for each respective one of the distributed power point control units, and wherein each of the control signals indicates a relationship between an input voltage and an output voltage of each respective one of the distributed power point control units, the control signals controlling the portions of the power such that the photovoltaic array generates a target current at a target voltage when the distributed power point control units power the loads.

2. The system of claim 1, wherein the target current and the target voltage correspond to substantially a maximum power point of the photovoltaic array.

3. The system of claim 1, wherein the distributed power point control controller is further configured to determine an amount of power each one of the distributed power point control units is to receive from the photovoltaic array.

4. The system of claim 1, wherein the distributed power point control controller is further configured to determine a distribution of the target current across the distributed power point control units.

5. The system of claim 1, wherein the distributed power point control controller is further configured to receive sensor data from at least one sensor circuit and to adjust the control signal for at least one of the distributed power point control units based on the sensor data.

6. The system of claim 1, wherein the distributed power point control controller is further configured to selectively alter at least one the loads so that the photovoltaic array generates the target current at the target voltage when the distributed power point control units power the loads.

7. The system of claim 1, wherein the distributed power point control controller is further configured to determine the target current and the target voltage for the photovoltaic array.

8. A distributed power point control circuit comprising:
a control signal generator circuit configured to generate a control signal for each respective one of a plurality of distributed power point control units, wherein the distributed power point control units are configured to receive power from a photovoltaic array, wherein each one of the distributed power point control units is configured to supply a portion of the power received from the photovoltaic array to a corresponding load, and wherein the control signal indicates a relationship between current received and current supplied by each respective one of the distributed power point controls; and
a controller module that directs the control signal generator circuit to generate the control signal for each respective one of the distributed power point control units such that the photovoltaic array generates a target power when each of the distributed power point control units powers the corresponding load.

9. The distributed power point control circuit of claim 8 further comprising a sensor module that receives sensor data from a plurality of sensor circuits electrically coupled to or included in respective ones of the distributed power point control units, wherein the controller module determines how to generate the control signal for each respective one of the distributed power point control units based on the sensor data.

10. The distributed power point control circuit of claim 8 further comprising a sensor module configured to receive sensor data indicating how much power is generated by the photovoltaic array, and the controller module is configured to direct the control signal generator circuit, in response to detection of a decrease in power generated by the photovoltaic array, to adjust the control signal for at least one of the distributed power point control units such that current supplied by the at least one of the distributed power point control units decreases.

11. The distributed power point control circuit of claim 8, wherein the controller module of the distributed power point control circuit negotiates with at least one other power point tracker circuit to determine which of the power point tracker circuits is a master.

12. The distributed power point control circuit of claim 8 further comprising at least one of the distributed power point control units.

13. The distributed power point control circuit of claim 8, wherein the control signal generator circuit comprises a network interface controller.

14. The distributed power point control circuit of claim 8, wherein the control signal for at least one of the distributed power point control units comprises a data packet indicative of a duty cycle of a periodic signal, and the control signal generator circuit transmits the data packet to the at least one of the distributed power point control units over a data network.

15. A method to control an operating point of a photovoltaic array, the method comprising:
powering each of a plurality of loads from the photovoltaic array; and
controlling at least one of a voltage and a current provided to each of the loads, the controlling being as a function of the operating point of the photovoltaic array, the at least one of the voltage and the current being controlled by a processor with a plurality of control signals that correspond to the loads.

16. The method of claim 15 further comprising:
receiving sensor data with the processor, the sensor data indicating an amount of power generated by the photovoltaic array; and
adjusting the control signal for at least one of the loads with the processor until the photovoltaic array generates a target power.

17. The method of claim 15 further comprising:
receiving sensor data indicating a voltage supplied to each respective one of the loads; and
adjusting the control signal for at least one of the loads so that the voltage supplied to the at least one of the loads falls within a portion of a voltage range.

18. The method of claim 15 further comprising:
altering the control signal for at least one of the loads to cause an increase in current drawn from the photovoltaic array by the at least one of the loads;
receiving sensor data indicating an amount of power each corresponding one of the loads draws from the photovoltaic array;
determining whether power drawn from the photovoltaic array decreases in response to altering the control signal; and
adjusting, in response to a determination that the power drawn from the photovoltaic array decreased, the control signal for the at least one of the loads to cause a decrease in current drawn from the photovoltaic array by the at least one of the loads.

19. The method of claim 15 further comprising causing a change in at least one of the loads in addition to generating the control signals so that the photovoltaic array generates the target power while powering the loads.

20. A tangible non-transitory computer-readable medium comprising instructions executable with a processor, the instructions comprising:
a controller module configured to transmit a control signal to each respective one of a plurality of distributed power point control units, wherein the distributed power point control units are configured to receive power from a photovoltaic array,
each one of the distributed power point control units is configured to supply a portion of the power received from the photovoltaic array to a corresponding one of a plurality of loads, and
the controller module determines the control signal for each respective one of the distributed power point control units that causes the photovoltaic array to generate a target power when the distributed power point control units power the loads.

21. The tangible non-transitory computer-readable medium of claim 20, wherein the controller module adjusts the control signal for each respective one of the distributed power point control units so that the control signal for any one of the distributed power point control units is out of phase with the control signal for the other distributed power point control units.
